(19) United States
(12) Patent Application Publication
(10) Pub. No.: US 2017/0114758 A1
(43) Pub. Date: Apr. 27, 2017

(54) POSITIONING AN ACTIVATED CARBON FILTER IN AN ARRANGEMENT FOR ITS REGENERATION

(71) Applicant: Eagle Actuator Components GmbH & Co. KG, Weinheim (DE)

(72) Inventor: Joerg Bittner, Novi, MI (US)

(21) Appl. No.: 15/279,448

(22) Filed: Sep. 29, 2016

Related U.S. Application Data
(60) Provisional application No. 62/234,053, filed on Sep. 29, 2015.

(51) Int. Cl. F02M 35/02; B01D 46/00; B60K 15/03; F02M 35/10; F02M 35/09; B01D 53/04; F02M 35/024

(52) U.S. Cl. CPC F02M 35/0218; B01D 53/0446; B01D 46/0036; F02M 35/024; F02M 35/10157; F02M 35/09; B60K 15/03; B01D 2259/40086; B01D 2257/702; B01D 2253/102; B01D 2259/4516

(57) ABSTRACT

A filter arrangement includes an activated carbon filter, a fuel tank, an engine, at least one of an air filter or a dust filter, and at least one valve. The at least one valve is configured to allow fresh air to flow through the activated carbon filter in order to regenerate the carbon filter. The activated carbon filter is at least one of associated with the intake tract of the engine, integrated into the intake tract of the engine; or a component of a modular unit with the intake tract of the engine.

### CROSS REFERENCE TO RELATED APPLICATIONS

This application claims benefit to U.S. Provisional Patent Application No. 62/234,053, filed on Sep. 29, 2015.

### FIELD

The invention relates to filters and filter arrangements, and more particularly, to activated carbon filters and arrangements including activated carbon filters.

### BACKGROUND

In order to protect the environment against fuel vapor emissions and comply with relevant legislation, gasoline-powered motor vehicles typically have an activated carbon filter. The fuel tank system of a motor vehicle is aerated or vented via the activated carbon filter.

During the venting phase of a fuel tank, which can be necessary due to high outside temperatures or a high elevation, the hydrocarbons contained in the escaping fuel vapor are filtered out by means of adsorption on the surface of the activated carbon. Then virtually pure air escapes from the activated carbon filter into the atmosphere.

Venting the fuel tank involves two states, namely, operation venting and refueling venting. Operation venting is essentially prescribed by environmental conditions and the driving states. During refueling venting, the vapor component is displaced from the fuel tank when liquid fuel is being filled into the tank. Since refueling is carried out relatively quickly, considerably higher throughput rates occur during refueling venting than during operation venting.

The processes that take place during refueling venting call for special attention, particularly in the United States, where the applicable laws require that all motor vehicles have to be equipped with a so-called onboard refueling vapor recovery (ORVR) system. The ORVR system captures fuel vapors that escape from the fuel tank during refueling. This is done by means of the above-mentioned activated carbon filter. For this reason, the activated carbon filters of motor vehicles in the United States are considerably larger than those, for example, in Europe. The reason for this is that, in Europe, the fuel vapors that are displaced from the fuel tank during refueling are drawn off at a filling opening by a removal device provided on the gas nozzle.

However, there are technical limits to the absorption capacity and the size of an activated carbon filter in a motor vehicle. This is why an activated carbon filter has to be regenerated, so that it can continue to absorb vapors. Normally, this is done by utilizing the negative pressure from the engine so that fresh air is drawn in through the activated carbon filter and then metered into the combustion process as a function of the conditions and states of the engine. During the associated flushing of the activated carbon filter with fresh air, the hydrocarbons desorb from the surface of the activated carbon and are fed into the engine after having been mixed with fresh air. This is how the activated carbon filter is regenerated.

The most recent developments in the realm of engines are giving rise to drives that are ever more economical and efficient. It can be assumed that this trend will continue unabated. Measures such as downsizing, de-constricting intake systems, turbocharging, start-stop technologies or hybridization have markedly reduced the pressure potentials available for the regeneration of the activated carbon filter. For instance, the negative pressure available in motor vehicles is considerably less nowadays than it was in the past. The engine even stands still at times when start-stop technologies and hybrid operations are employed.

However, emissions stemming from the fuel and thus the loading of the activated carbon filter continue to occur. Therefore, it is of paramount importance for the pressure potentials available to be optimally used to flush the activated carbon filter or for measures to be taken that assist in the flushing procedure. In the case of low negative pressures, in particular, it is necessary to generate the same amounts of flushing air and/or to generate a larger flushing air flow during the short periods when higher negative pressures are available. In this context, it is clear that, in order to attain the requisite higher flushing air flow, it is also necessary to reduce flow-related losses in the system. Before this backdrop, a conceivable approach would be to de-constrict the lines by enlarging their inner diameter. This, however, is not always technically feasible and sometimes it is relatively expensive.

### SUMMARY

In an embodiment, the present invention provides a filter arrangement includes an activated carbon filter, a fuel tank, an engine, at least one of an air filter or a dust filter, and at least one valve. The at least one valve is configured to allow fresh air to flow through the activated carbon filter in order to regenerate the carbon filter. The activated carbon filter is at least one of associated with the intake tract of the engine, integrated into the intake tract of the engine; or a component of a modular unit with the intake tract of the engine.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 is a schematic view of the usual positioning of an activated carbon filter relative to an engine and to a turbocharger, in an arrangement according to the state of the art;

FIG. 2 depicts an arrangement according to an embodiment of the invention in which the activated carbon filter is positioned near the intake tract, namely, near the fresh-air intake line of the turbocharger;

FIG. 3 depicts another arrangement according to an embodiment of the invention in which the activated carbon filter is positioned near the intake tract, namely, near the fresh-air intake line of the turbocharger, whereby a mixing valve is used;

FIG. 4 depicts another arrangement according to an embodiment of the invention in which the activated carbon filter is positioned near the intake tract, namely, near the turbocharger, whereby a structure having few lines is achieved by using a housing section; and

FIG. 5 depicts another arrangement according to an embodiment of the invention which can preferably be used in engines or in naturally aspirated engines that are not supercharged, in which the activated carbon filter is positioned near the intake tract of an engine, namely, near its intake manifold, whereby a structure having few lines is likewise achieved by using a housing section.

### DETAILED DESCRIPTION

Embodiments described herein configure the regeneration system of a motor vehicle in such a way so as to improve the regeneration of the activated carbon filter.

A special positioning of an activated carbon filter in the regeneration and air-feed system of a motor vehicle is described herein. Traditionally, the activated carbon filter is situated in the rear part of a motor vehicle, especially near the wheel wells or near the fuel tank. Such traditional position and similar positions of the activated carbon filter give rise to long lines for the conveyance of air which, owing to negative-pressure conditions that prevail in modern motor vehicles, would have to be shortened.

The special positioning of an activated carbon filter described herein can be achieved in that the activated carbon filter is associated with the intake tract of the engine, integrated into it, and/or forms a modular unit with it. According to an embodiment of the invention, the activated carbon filter is positioned as close as possible to the intake tract of the engine, or is even integrated into it. In this manner, system-related flow losses caused by the lines during the regeneration are markedly reduced since, on the one hand, the length of the lines is considerably shortened and, on the other hand, a more effective enlargement of their inner diameters can be effectuated more easily.

The special positioning of the activated carbon filter described herein makes it possible for the activated carbon filter to not be arranged in the rear part of the motor vehicle, especially not near the rear wheel wells or near the fuel tank. Consequently, the lines can be effectively shortened.

The air filter and the dust filter could be combined to form a modular unit or modular group. As a result, the air filter and the dust filter can be positioned in very close proximity to each other. Preferably, the air filter forms a structural unit with the dust filter.

The activated carbon filter can be situated upstream from the intake manifold of the engine and/or from the turbocharger in such a way that fresh air flowing through the dust filter and/or through the air filter can be conveyed into the activated carbon filter through at least one feed line or at least one diagnostic unit. In this manner, the length and number of lines that convey fresh air to the activated carbon filter can be effectively reduced.

In embodiments of the invention, a second feed line can open up into a feed point of a fresh-air intake line of a turbocharger. In this manner, fresh air carrying hydrocarbons with it could be fed directly and over a short distance into the turbocharger. It is then possible to dispense with additional lines.

In embodiments of the invention, a fresh-air main line coming from the air filter could open up into the feed point. In this manner, the fresh air laden with hydrocarbons can be mixed with pure fresh air and fed to the turbocharger.

The first feed line could be opened and closed by a first feed line valve and/or the second feed line could be opened and closed by a second feed line valve and/or the fresh-air main line could be opened and closed by a fresh-air main line valve. In this manner, the entire regeneration system can be flexibly adapted to different operating states of the engine.

A mixing valve that regulates the composition of the fresh air flowing into the fresh-air intake line could be arranged at the feed point. In this manner, the hydrocarbon content of the fresh air fed to the engine can be set.

The activated carbon filter and the air filter could be combined to form a modular unit or modular group. As a result, the air filter and the activated carbon filter can be positioned in very close proximity to each other. Preferably, the air filter forms a structural unit with the activated carbon filter.

In embodiments of the invention, there could be a fluid-carrying housing section into which a valve is integrated that regulates the composition of the fresh air that is fed to the intake manifold and/or to the turbocharger disposed upstream from the intake manifold of the engine and/or upstream from the turbocharger, whereby this fresh air consists of a first air mass flow coming from the activated carbon filter and of a second air mass flow coming from the air filter. In this manner, the hydrocarbon content of the fresh air fed to the engine can be set using a structure having few lines.

The housing section can open up directly into the intake manifold or into a turbocharger. In this context, the housing section can be configured so as to be tubular or sleeve-like and so as to accommodate all of the essential components, particularly the integrated valve. The housing section makes it possible to save on lines that come from the air filter and/or from the activated carbon filter and that lead to the turbocharger or to the intake manifold.

The arrangement described here can be employed to optimize the regeneration or to reduce the flow losses or pressure losses in the regeneration system of a motor vehicle. The described arrangement permits a flexible adaptation of the system.

A method to optimize the regeneration of an activated carbon filter in an arrangement of the type described herein encompasses one or more of the following method steps:
associating the activated carbon filter with the intake tract of the engine,
integrating the activated carbon filter into the intake tract of the engine and/or
forming a structural unit consisting of the engine and the activated carbon filter. The method could also encompass the following method step:
reducing the flow losses or pressure losses in the arrangement.

The drawing shows the following:

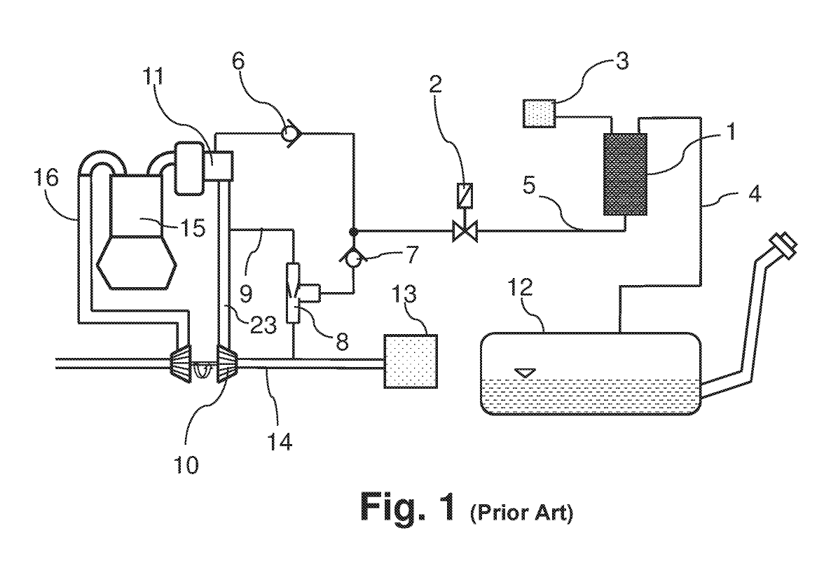

FIG. 1 shows an arrangement known from the state of the art, comprising an activated carbon filter 1, a regeneration valve 2, a dust filter 3, a tank venting line 4, a regeneration line 5, a non-return valve 6 for the suction operation, a non-return valve 7 for the turbocharger, an ejector 8, a pressure line 9 leading to the ejector 8, a turbocharger 10, an intake manifold 11, a fuel tank 12, an air filter 13, a fresh-air intake line 14, an engine 15 and an exhaust gas line 16.

In FIG. 1, the regeneration valve 2 allows fresh air to flow through the activated carbon filter 1, regenerating it in this process when the regeneration valve 1 is open. Negative pressure generated by the engine 15 or by the turbocharger 10 draws in fresh air via the dust filter 3 through the activated carbon filter 1 and conveys it, laden with hydrocarbons, through the regeneration line 5 into the fresh-air intake line 14 and then to the turbocharger 10 or to the intake manifold 11.

There is a charge air line 23 coming from the turbocharger 10 and leading to the intake manifold 11 of the engine. When the engine 11 is only in its suction operation, the fresh air laden with carbon is drawn in through the non-return valve 6 directly into the intake manifold 11. During turbocharging operation, the fresh air laden with hydrocarbons is drawn in through the non-return valve 7 into the fresh-air intake line 14 of the turbocharger 10 and conveyed from there, via the charged-air line 23, to the intake manifold 11.

The activated carbon filter 1 is arranged near the fuel tank 12, namely, normally in the rear, in a motor vehicle (not shown here). The engine 15 is normally located in the front, so that the regeneration line 5 is usually more than three meters long.

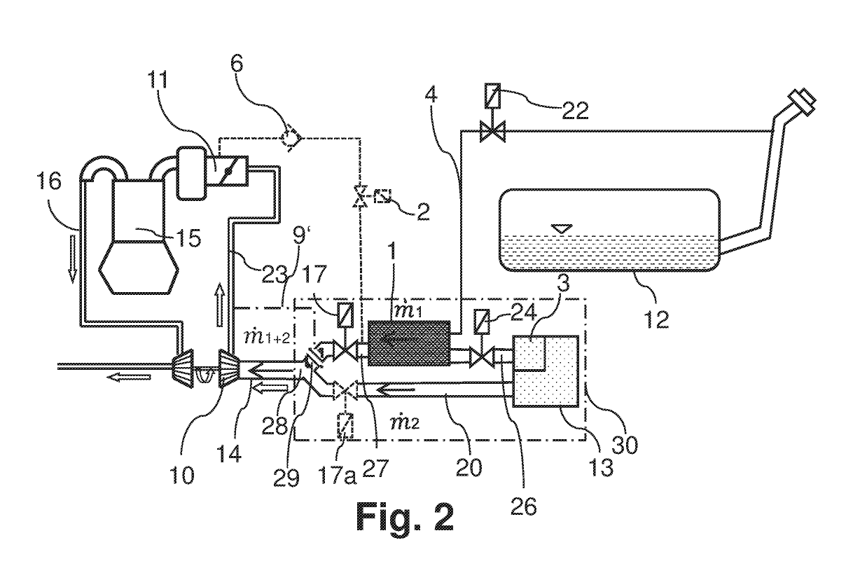

FIG. 2 shows an arrangement according to an embodiment of the invention comprising an activated carbon filter 1, a fuel tank 12, an engine 15, an air filter 13 and a dust filter 3 as well as at least one valve, namely, a first feed line valve 24, whereby fresh air can flow through the activated carbon filter 1, regenerating it in this process when the first feed line valve 24 is open. The activated carbon filter 1 is associated with the intake tract of the engine 15 or it is integrated into it or else it forms a modular unit with it.

FIG. 2 shows an arrangement in which the tank venting line 4 comes from the fuel tank 12 and opens up directly into the activated carbon filter 1. The tank venting line 4 can be opened and closed by means of a tank stop valve 22. The tank stop valve 22 is open during refueling and closed during the regeneration of the activated carbon filter 1. The air filter 13 and the dust filter 3 are combined to form a modular unit.

The activated carbon filter 1 is situated upstream from the intake manifold 11 of the engine 15 and from the turbocharger 10 in such a way that fresh air flowing through the dust filter 3 is conveyed into the activated carbon filter 1 through one feed line 26 at the most. A second feed line 27 coming from the activated carbon filter 1 opens up into a feed point 28 of a fresh-air intake line 14 of the turbocharger 10. A fresh-air main line 20 coming from the air filter 13 likewise opens up into the feed point 28. The first feed line 26 can be opened and closed by the first feed line valve 24, while the second feed line 27 can be opened and closed by a second feed line valve 17.

The broken line indicates that the fresh-air main line 20 can also be opened and closed by a fresh-air main line valve 17a. The broken lines also indicate that a regeneration valve 2 as well as a non-return valve 6 can also be provided for the suction operation of the engine 15.

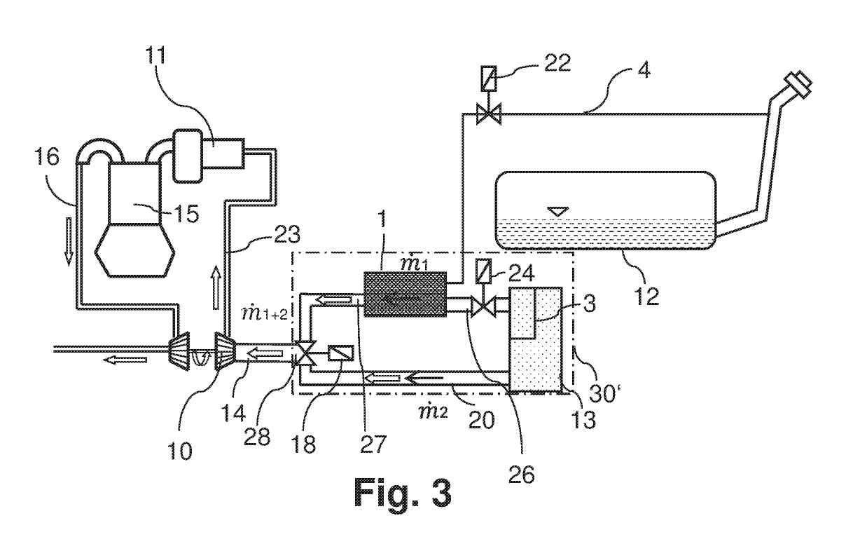

FIG. 3 shows an arrangement according to an embodiment of the invention comprising an activated carbon filter 1, a fuel tank 12, an engine 15, an air filter 13 and a dust filter 3 as well as at least one valve, namely, the first feed line valve 24, whereby fresh air can flow through the activated carbon filter 1, regenerating it in this process when the first feed line valve 24 is open. The activated carbon filter 1 is associated with the intake tract of the engine 15 or it is integrated into it or else it forms a modular unit with it.

The air filter 13 and the dust filter 3 are combined to form a modular unit. The activated carbon filter 1 is situated upstream from the intake manifold 11 of the engine 15 and from the turbocharger 10 in such a way that fresh air flowing through the dust filter 3 and the air filter 13 is conveyed into the activated carbon filter 1 through one feed line 26 at the most.

A second feed line 27 coming from the activated carbon filter 1 opens up into a feed point 28 of a fresh-air intake line 14 of the turbocharger 10. A fresh-air main line 20 coming from the air filter 13 likewise opens up into the feed point 28.

The first feed line 26 can be opened and closed by the first feed line valve 24. At the feed point 28, there is a mixing valve 18 that regulates the composition of the fresh air flowing into the fresh-air intake line 14. The fresh air m1+2 that flows into the fresh-air intake line 14 consists of a first air mass flow m1 coming directly from the activated carbon filter 1 and of a second air mass flow m2 coming directly from the air filter 13. The designation of the mass flows also applies to FIG. 2.

FIG. 3 concretely shows an arrangement in which a mixing valve 18 is situated between the activated carbon filter 1 and the fresh-air intake line 14 leading to the turbocharger 10.

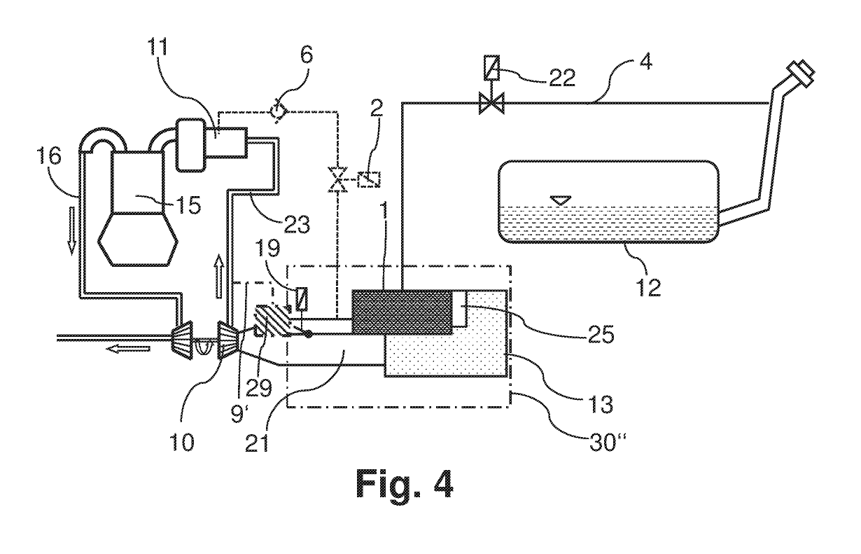

FIG. 4 shows an arrangement according to an embodiment of the invention comprising an activated carbon filter 1, a fuel tank 12, an engine 15, an air filter 13 and at least one valve, namely, the integrated valve 19, whereby fresh air can flow through the activated carbon filter 1, regenerating it in this process when the integrated valve 19 is at least partially open. The activated carbon filter 1 is associated with the intake tract of the engine 15 and it is integrated into it, and it forms a modular unit with it.

The activated carbon filter 1 is situated upstream from the intake manifold 11 of the engine 15 and from the turbocharger 10 in such a way that fresh air flowing through the air filter 13 is conveyed into the activated carbon filter 1 through one diagnostic unit 25 at the most. However, it is also possible not to provide any diagnostic units 25. The activated carbon filter 1 and the air filter 13 are combined to form a modular unit.

The turbocharger 10 is situated upstream from a fluid-carrying housing section 21 into which the valve 19 is integrated that regulates the composition of the fresh air that is conveyed to the turbocharger 10, whereby this fresh air consists of a first air mass flow coming from the activated carbon filter 1 and of a second air mass flow coming from the air filter 13. The housing section 21 opens up directly into the turbocharger 15. FIG. 4 shows an arrangement in which the integrated valve 19 is arranged between the activated carbon filter 1 and the turbocharger 10.

The broken lines indicate that a regeneration valve 2 and a non-return valve 6 could also be provided for the suction operation of the engine 15.

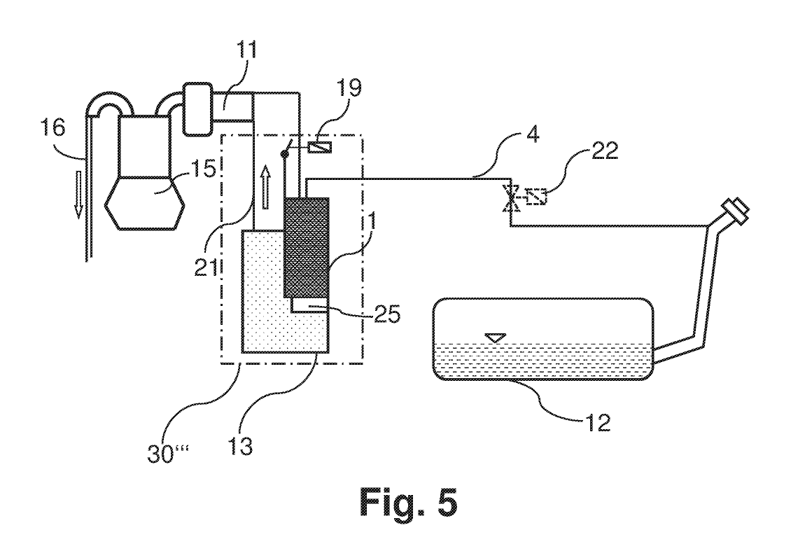

FIG. 5 shows an arrangement according to an embodiment of the invention comprising an activated carbon filter 1, a fuel tank 12, an engine 15, an air filter 13 and at least one valve, namely, the integrated valve 19, whereby fresh air can flow through the activated carbon filter 1, regenerating it in this process when the integrated valve 19 is at least partially open. The activated carbon filter 1 is associated with the intake tract of the engine 15 and it is integrated into it, and it forms a modular unit with it.

The activated carbon filter 1 is situated upstream from the intake manifold 11 of the engine 15 in such a way that fresh air flowing through the air filter 13 is conveyed into the activated carbon filter 1 through one diagnostic unit 25 at the most. Here, too, it is possible for the diagnostic unit 25 to be absent.

The activated carbon filter 1 and the air filter 13 are combined to form a modular unit. The intake manifold 11 of the engine 15 is situated upstream from a fluid-carrying housing section 21 into which the valve 19 is integrated that regulates the composition of the fresh air that is conveyed to the intake manifold 11, whereby this fresh air consists of a first air mass flow coming from the activated carbon filter 1 and of a second air mass flow coming from the air filter 13. The housing section 21 opens up directly into the intake manifold 11.

FIG. 5 shows an arrangement in which the integrated valve 19 is situated between the activated carbon filter 1 and the intake manifold 11 of the engine 15. The integrated valve 19 is situated inside the housing section 21.

The broken lines indicate that a tank stop valve 22 could likewise be provided.

In FIGS. 2 and 4, the dash-dot lines each indicate a pressure line 9′ that could be fluid-connected to a likewise dash-dot and cross-hatched element 29. The element 29 has a regeneration-promoting effect and could be configured, for instance, as an ejector. An ejector 8 is depicted in FIG. 1. The element 29 can be coordinated with the applicable parameters of the arrangement in question.

The use of dash-dot lines is meant to expressly show in the arrangements that the regeneration-promoting element 29 and the pressure line 9′ can be, but do not necessarily have to be, provided.

In FIGS. 2 to 5, the dash-dot rectangular boxes 30, 30′, 30″, 30′″ indicate that the components present inside the boxes 30, 30′, 30″, 30′″ can be combined to form a unit, but are not necessarily combined to form a unit. This unit can be associated with the intake tract of the engine 15, or else it can be integrated into it and/or form a modular unit with it.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A filter arrangement comprising:
an activated carbon filter;
a fuel tank;
an engine;
at least one of an air filter or a dust filter; and
at least one valve,
wherein the at least one valve is configured to allow fresh air to flow through the activated carbon filter in order to regenerate the carbon filter, and
wherein the activated carbon filter is at least one of associated with the intake tract of the engine, integrated into the intake tract of the engine; or a component of a modular unit with the intake tract of the engine.

2. The filter arrangement according to claim 1, wherein the air filter and the dust filter are combined to form a modular unit.

3. The filter arrangement according to claim 1, wherein the activated carbon filter is situated upstream from at least one of an intake manifold of the engine (15) or a turbocharger in such a way that fresh air flowing through at least one of the dust filter or through the air filter is conveyed into the activated carbon filter through at least one feed line or at least one diagnostic unit.

4. The filter arrangement according to claim 3, wherein a second feed line coming from the activated carbon filter opens up into a feed point of a fresh-air intake line of the turbocharger.

5. The filter arrangement according to claim 4, wherein a fresh-air main line coming from the air filter opens up from the air filter into the feed point.

6. The filter arrangement according to claim 3, wherein at least one of the first feed line can be opened and closed by a first feed line valve, the second feed line can be opened and closed by a second feed line valve, or the fresh-air main line can be opened and closed by a fresh-air main line valve.

7. The filter arrangement according to claim 4, wherein a mixing valve that regulates the composition of the fresh air flowing into the fresh-air intake line is arranged at the feed point.

8. The filter arrangement according to claim 1, wherein the activated carbon filter and the air filter are combined to form a modular unit.

9. The filter arrangement according to claim 1, wherein a fluid-carrying housing section is disposed upstream from at least one of an intake manifold of the engine or a turbocharger, wherein a valve that regulates the composition of the fresh air that is conveyed to at least one of the intake manifold or the turbocharger is integrated into the fluid carrying housing section, wherein the fresh air comprises a first air mass flow coming from the activated carbon filter and a second air mass flow coming from the air filter.

10. The filter arrangement according to claim 9, wherein the housing section opens up into at least one of the intake manifold or the turbocharger.

11. A method to optimize the regeneration of an activated carbon filter in a filter arrangement, the method comprising at least one of:
associating the activated carbon filter with at least one of an intake tract of an engine;
integrating the activated carbon filter into the intake tract of the engine; or
forming a structural unit consisting of the engine and the activated carbon filter,
wherein the filter arrangement includes an activated carbon filter, a fuel tank, an engine, at least one of an air filter or a dust filter, and at least one valve, and
wherein the at least one valve is configured to allow fresh air to flow through the activated carbon filter in order to regenerate the carbon filter.
